(19) United States
(12) Patent Application Publication
(10) Pub. No.: US 2025/0023423 A1
(43) Pub. Date: Jan. 16, 2025

(54) OSCILLATING POWER GENERATOR

(71) Applicant: CHEN-HUI KUO, CHANGHUA (TW)

(72) Inventor: CHEN-HUI KUO, CHANGHUA (TW)

(73) Assignee: LONGIWIN INVESTMENT CO., LTD., CHANGHUA (TW)

(21) Appl. No.: 18/220,187

(22) Filed: Jul. 10, 2023

(51) Int. Cl. H02K 7/065; H02K 1/17; H02K 1/34

(52) U.S. Cl. CPC H02K 7/065; H02K 1/17; H02K 1/34

(57) ABSTRACT

An oscillating power generator may include an oscillating apparatus, an assisting oscillation apparatus, and a power generation apparatus. The oscillating apparatus has an oscillating portion, and at least a clump weight is installed inside the oscillating portion to change the position of the gravity center of the oscillating portion, and to keep the horizontal position of the gravity center of the oscillating portion below the rotational center of the oscillating portion, so that the oscillating portion is adapted to oscillate from side to side and eventually return to a stable state where the rotational center, the gravity center, and the pivot point are aligned in a straight line. Each of two lateral sides of the oscillating portion comprises an oscillating magnetic portion. The assisting oscillation apparatus has two fixed magnetic portions, and the oscillating magnetic portion and fixed magnetic portion are adapted to repel each other.

### FIELD OF THE INVENTION

The present invention relates to a power generator and more particularly to an oscillating power generator with extending the oscillating time.

### BACKGROUND OF THE INVENTION

Oscillation is a process of using gravity and initial force to repeatedly balance, and the process of oscillating left and right will be affected by the center of gravity and the gravity, and in the ordinary environment such a movement will eventually stop because of friction and energy conversion to heart. The oscillation exists in daily life, such as metronomes, tumblers and other devices, and an oscillating motion device has an assisted device actuated by the gravity, which can allow the oscillating motion device to act on the oscillating motion for a period of time without applying continuous force.

However, the conventional oscillating power generator has following disadvantages: although the oscillating movement has the characteristics that the user can apply the initial force and continue to operate with gravity for a period of time, and can generate electricity semi-automatically, the oscillating movement will eventually stop due to friction and energy conversion into heat and other energy, so that it is necessary to find a way to extend the time of power generation. Therefore, there remains a need for a new and improved design for an oscillating power generator to overcome the problems presented above.

### SUMMARY OF THE INVENTION

The present invention provides an oscillating power generator comprising an oscillating apparatus, an assisting oscillation apparatus, and a power generation apparatus. The oscillating apparatus has an oscillating portion, and at least a clump weight is installed inside the oscillating portion so as to change the position of the gravity center of the oscillating portion, and to keep the horizontal position of the gravity center of the oscillating portion below the rotational center of the oscillating portion, so that the oscillating portion is adapted to oscillate from side to side and eventually return to a stable state where the rotational center, the gravity center, and the pivot point are aligned in a straight line. Each of two lateral sides of the oscillating portion comprises an oscillating magnetic portion. The assisting oscillation apparatus formed outside of the oscillating apparatus has two fixed magnetic portions, and the oscillating magnetic portion and the fixed magnetic portion are adapted to repel each other. The power generation apparatus is configured to generate electricity through the oscillating motion of the oscillating portion and to store electricity therein. When the user applies force to the oscillating portion, the gravity center of oscillating portion is adapted to deviate from the pivot point and the rotational center, and the oscillating portion is configured to repeatedly oscillate from side to side like a tumbler to generate electricity through the power generation apparatus. The oscillating magnetic portion and the fixed magnetic portion are mutually repulsion, and the two oscillating magnetic portions are respectively located at the two lateral sides of the oscillating portion, so that when the oscillating portion is oscillated, the oscillating magnetic portion is propelled by the magnetic force of the fixed magnetic portion, and the kinetic energy of the oscillating apparatus is supplemented by the torque generated by the magnetic repulsion, thereby prolonging the oscillating time of the oscillating apparatus.

Comparing with conventional oscillating power generator, the present invention is advantageous because: (i) by utilizing the magnetic force of the assisting oscillation apparatus to obtain additional kinetic energy, the oscillation time of the oscillating portion is extended, so as to reduce the frequency at which the user needs to apply the initial force; and (ii) the oscillating apparatus can be combined with instruments that possess oscillating movements such as metronomes and tumbler toy, so as to enhance the entertainment value and visual appeal while achieving the effect of power generation.

### BRIEF DESCRIPTION OF THE DRAWINGS

FIG. 1 is a three-dimensional assembly view of an oscillating power generator of the present invention.

FIG. 2 is a front view of the oscillating power generator of the present invention.

FIG. 3 is a schematic view illustrating an oscillating apparatus of the oscillating power generator is oscillated to left side in the present invention.

FIG. 4 is a schematic view illustrating the oscillating apparatus of the oscillating power generator is oscillated to right side in the present invention.

FIG. 5 is a front view of the second embodiment of the oscillating power generator in the present invention.

FIG. 6 is a schematic view of the oscillating state of the oscillating power generator in the present invention.

FIG. 7 is a front view of the third embodiment of the oscillating power generator in the present invention.

FIG. 8 is a front view of the fourth embodiment of the oscillating power generator in the present invention.

FIG. 9 is a schematic view illustrating the oscillating state of the oscillating power generator in the present invention.

### DETAILED DESCRIPTION OF THE INVENTION

The detailed description set forth below is intended as a description of the presently exemplary device provided in accordance with aspects of the present invention and is not intended to represent the only forms in which the present invention may be prepared or utilized. It is to be understood, rather, that the same or equivalent functions and components may be accomplished by different embodiments that are also intended to be encompassed within the spirit and scope of the invention.

Unless defined otherwise, all technical and scientific terms used herein have the same meaning as commonly understood to one of ordinary skill in the art to which this invention belongs. Although any methods, devices and materials similar or equivalent to those described can be used in the practice or testing of the invention, the exemplary methods, devices and materials are now described.

All publications mentioned are incorporated by reference for the purpose of describing and disclosing, for example, the designs and methodologies that are described in the publications that might be used in connection with the presently described invention. The publications listed or discussed above, below and throughout the text are provided solely for their disclosure prior to the filing date of the present application. Nothing herein is to be construed as an admission that the inventors are not entitled to antedate such disclosure by virtue of prior invention.

In order to further understand the goal, characteristics and effect of the present invention, a number of embodiments along with the drawings are illustrated as following:

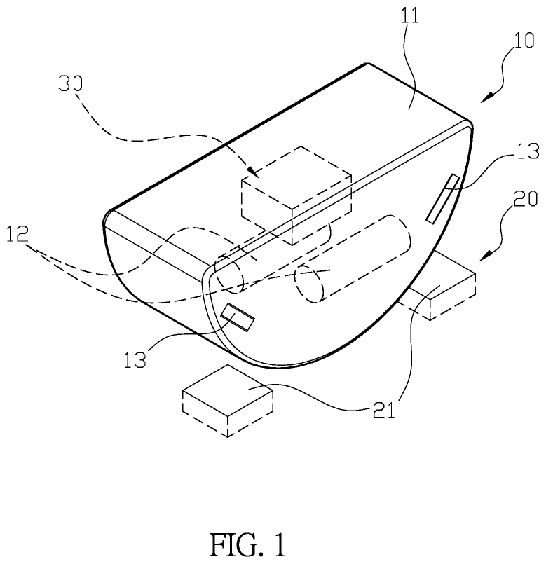

Referring to FIGS. 1 to 4, the present invention provides an oscillating power generator comprising an oscillating apparatus (10), an assisting oscillation apparatus (20), and a power generation apparatus (30). The oscillating apparatus (10) has an oscillating portion (11), and at least a clump weight (12) is installed inside the oscillating portion (11) so as to change the position of the gravity center of the oscillating portion (11), and to keep the horizontal position of the gravity center of the oscillating portion (11) below the rotational center of the oscillating portion (11), so that the oscillating portion (11) is adapted to oscillate from side to side and eventually return to a stable state where the rotational center, the gravity center, and the pivot point are aligned in a straight line. Each of two lateral sides of the oscillating portion (11) comprises an oscillating magnetic portion (13). The assisting oscillation apparatus (20) formed outside of the oscillating apparatus (10) has two fixed magnetic portions (21), and the oscillating magnetic portion (13) and the fixed magnetic portion (21) are adapted to repel each other. The power generation apparatus (30) is configured to generate electricity through the oscillating motion of the oscillating portion (11) and to store electricity therein.

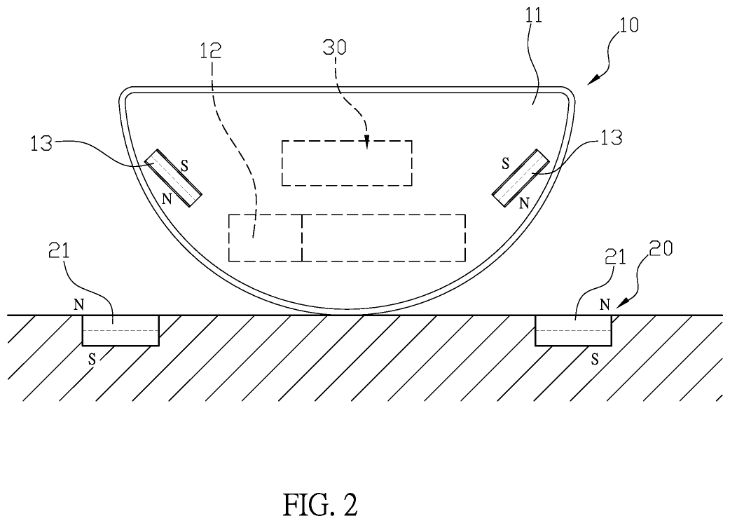

Referring to FIGS. 2 to 4, when the user applies force to the oscillating portion (11), the gravity center of oscillating portion (11) is adapted to deviate from the pivot point and the rotational center, and the oscillating portion (11) is configured to repeatedly oscillate from side to side like a tumbler to generate electricity through the power generation apparatus (30). The oscillating magnetic portion (13) and the fixed magnetic portion (21) are mutually repulsion, and the two oscillating magnetic portions (13) are respectively located at the two lateral sides of the oscillating portion (11), so that when the oscillating portion (11) is oscillated, the oscillating magnetic portion (13) is propelled by the magnetic force of the fixed magnetic portion (21), and the kinetic energy of the oscillating apparatus (10) is supplemented by the torque generated by the magnetic repulsion, thereby prolonging the oscillating time of the oscillating apparatus (10).

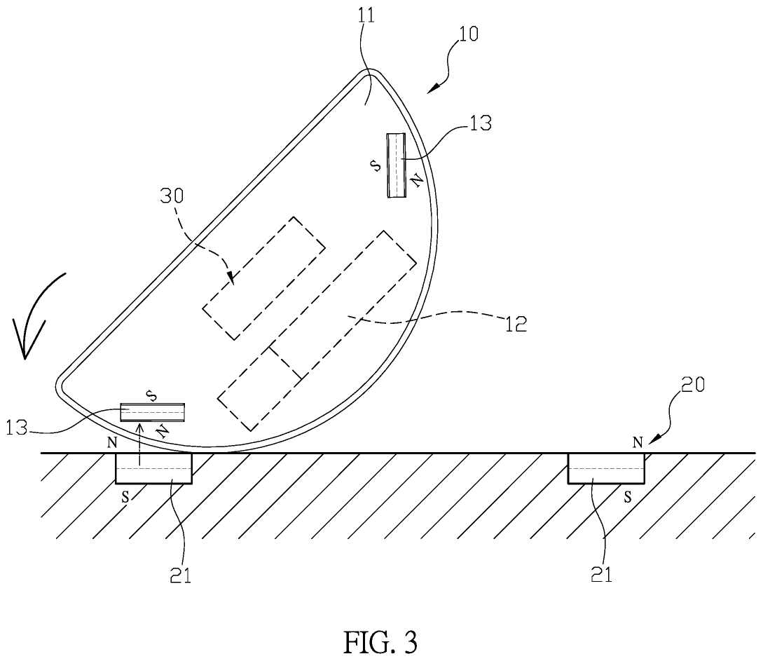

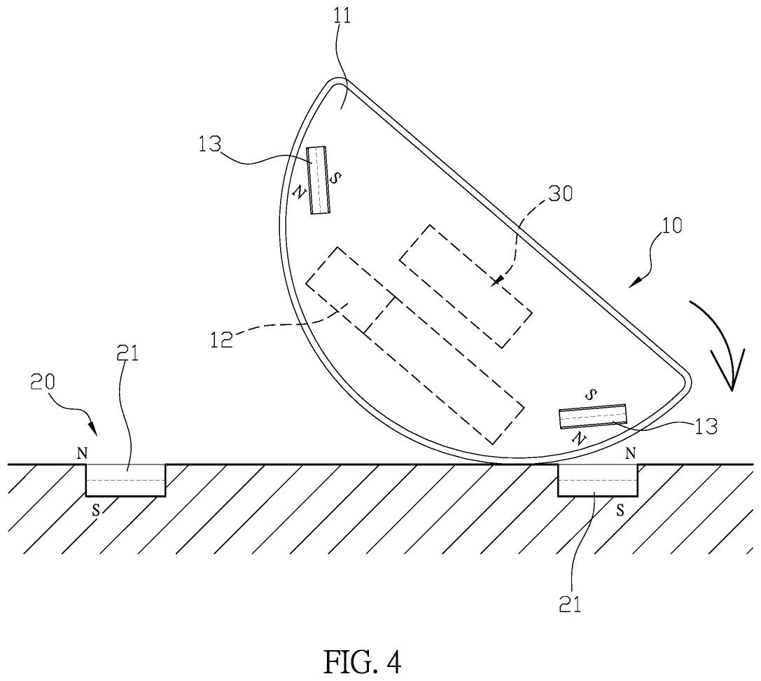

In actual application, the user can apply an initial force to drive the oscillating portion (11) to start repeatedly oscillating from side to side, and due to the friction and the energy conversion to the heat, the oscillating portion (11) is adapted to gradually loses its oscillation amplitude and eventually comes to a stop. Referring to FIGS. 3 and 4, the oscillating portion (11) has two oscillating magnetic portions (13) on each side, and the oscillating magnetic portion (13) and the fixed magnetic portion (21) are mutually repulsion, so that the additional kinetic energy is added to the magnetic force of the assisting oscillation apparatus (20) so as to prolong the oscillating time of the oscillating portion (11), thereby reducing the frequency at which the user needs to re-apply the initial force.

In one embodiment, referring to FIGS. 1 to 4, the oscillating portion (11) is formed in half-moon-shape.

In another embodiment, referring to FIGS. 1 to 4, the two oscillating magnetic portions (13) are respectively embedded on the left and right sides within the oscillating portion (11), while the two fixed magnetic portions (21) are positioned on the outer left and right sides beneath the oscillating portion (11).

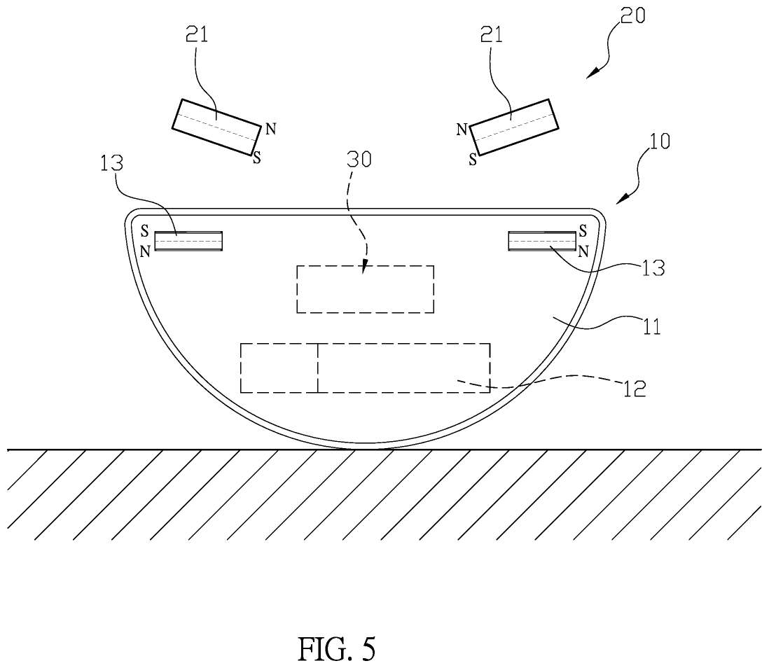

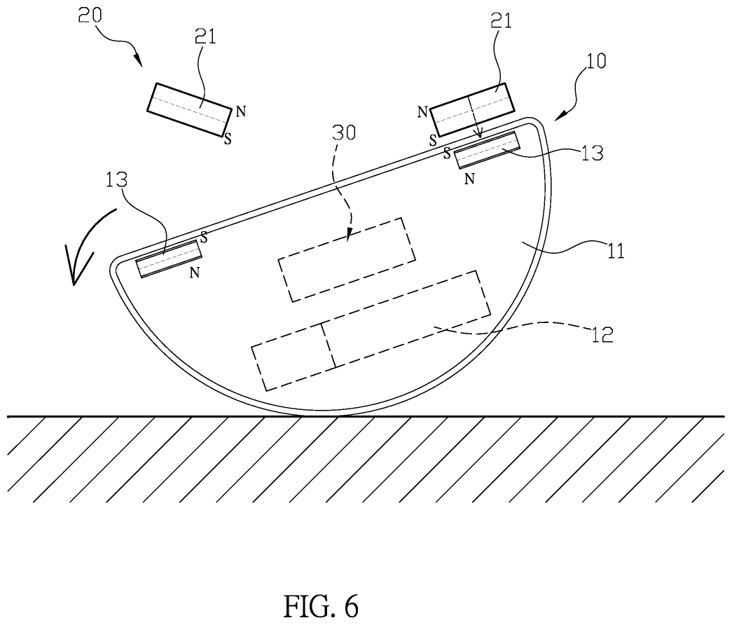

In a second embodiment, referring to FIGS. 5 and 6, the two oscillating magnetic portions (13) are respectively embedded on the left and right sides within the top of the oscillating portion (11), while the two fixed magnetic portions (21) are positioned on the outer left and right sides above the oscillating portion (11).

In a further embodiment, referring to FIGS. 1 to 6, the fixed magnetic portion (21) is a permanent magnet.

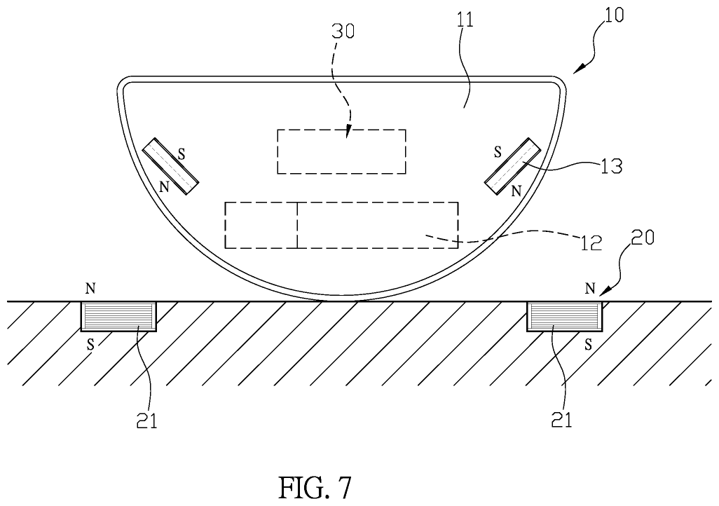

In still a further embodiment, referring to FIG. 7, the fixed magnetic portion (21) is a renewable-energy electromagnet; and the fixed magnetic portion (21) is a solar-charged electromagnet.

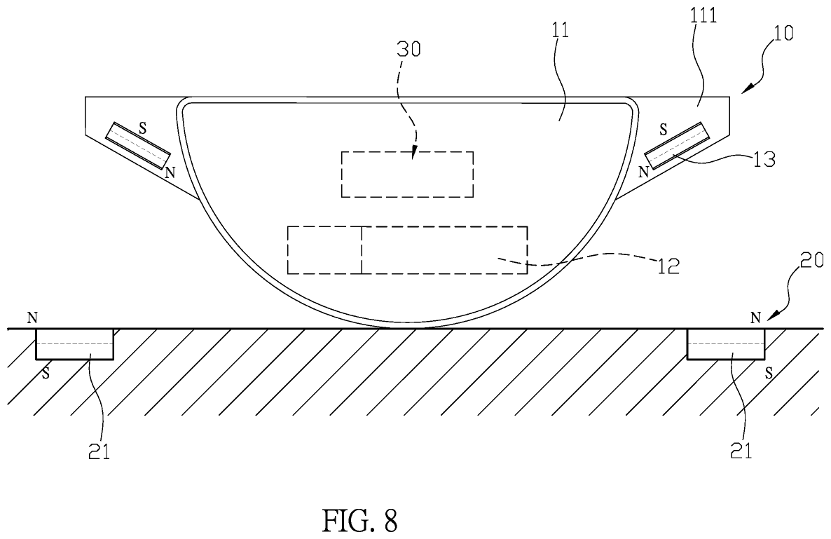

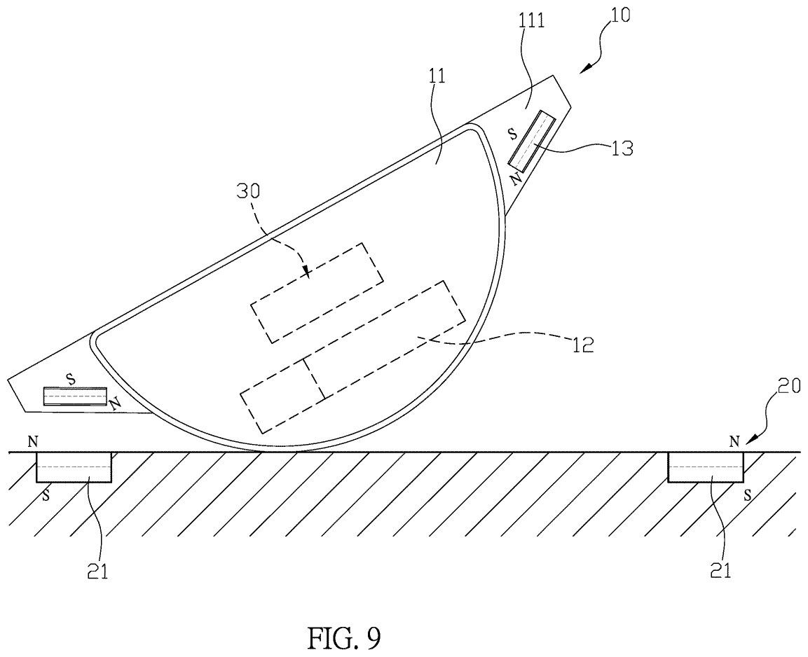

In an advantageous embodiment, referring to FIGS. 8 and 9, each of two lateral sides of the oscillating portion (11) has an extending portion (111) extended therefrom, and the two oscillating magnetic portions (13) are respectively installed in the two extending portions (111); the extending portion (111) is adapted to extend the distance from the oscillating magnetic portion (13) to the pivot point of the oscillating portion (11), so as to increase the torque generated by the repulsive magnetic force between the oscillating magnetic portion (13) and the fixed magnetic portion (21), thereby obtaining additional kinetic energy.

The method that the power generation apparatus (30) generates power through the oscillating portion (11) is exemplified without limitations as follows:

In still an advantageous embodiment, the power generation apparatus (30) generates power by using the Lenz's law to change the magnetic force between the magnet and the coil through repeated oscillations.

In a preferred embodiment, the power generation apparatus (30) is arranged on a surface in contact with the oscillating portion (11) when the oscillating portion oscillating, and the power generation apparatus (30) generates power by using Piezoelectric Effect to repeatedly exert pressure to the power generation apparatus (30) through the oscillating portion (11).

In another preferred embodiment, the power generation apparatus (30) generates power by using the oscillating portion (11) to carry out the mechanism motion.

Comparing with conventional oscillating power generator, the present invention is advantageous because: (i) by utilizing the magnetic force of the assisting oscillation apparatus (20) to obtain additional kinetic energy, the oscillation time of the oscillating portion (11) is extended, so as to reduce the frequency at which the user needs to apply the initial force; and (ii) the oscillating apparatus (10) can be combined with instruments that possess oscillating movements such as metronomes and tumbler toy, so as to enhance the entertainment value and visual appeal while achieving the effect of power generation.

Having described the invention by the description and illustrations above, it should be understood that these are exemplary of the invention and are not to be considered as limiting. Accordingly, the invention is not to be considered as limited by the foregoing description, but includes any equivalents.

What is claimed is:

1. An oscillating power generator comprising an oscillating apparatus, an assisting oscillation apparatus, and a power generation apparatus;
wherein the oscillating apparatus has an oscillating portion, and at least a clump weight is installed inside the oscillating portion so as to change the position of the gravity center of the oscillating portion, and to keep the horizontal position of the gravity center of the oscillating portion below the rotational center of the oscillating portion, so that the oscillating portion is adapted to oscillate from side to side and eventually return to a stable state where the rotational center, the gravity center, and the pivot point are aligned in a straight line; each of two lateral sides of the oscillating portion comprises an oscillating magnetic portion; the assisting oscillation apparatus formed outside of the oscillating apparatus has two fixed magnetic portions, and the oscillating magnetic portion and the fixed magnetic portion are adapted to repel each other; the power generation apparatus is configured to generate electricity through the oscillating motion of the oscillating portion and to store electricity therein; and
wherein when the user applies force to the oscillating portion, the gravity center of oscillating portion is adapted to deviate from the pivot point and the rotational center, and the oscillating portion is configured to repeatedly oscillate from side to side as a tumbler to generate electricity through the power generation apparatus; the oscillating magnetic portion and the fixed magnetic portion are mutually repulsion, and the two oscillating magnetic portions are respectively located at the two lateral sides of the oscillating portion, so that when the oscillating portion is oscillated, the oscillating magnetic portions are propelled by the magnetic force of the fixed magnetic portions, and the kinetic energy of the oscillating apparatus is supplemented by the torque generated by the magnetic repulsion, thereby prolonging the oscillating time of the oscillating apparatus.

2. The oscillating power generator of claim 1, wherein the oscillating portion is formed in half-moon-shape.

3. The oscillating power generator of claim 1, wherein the two oscillating magnetic portions are respectively embedded on the left and right sides within the oscillating portion, while the two fixed magnetic portions are positioned on the outer left and right sides beneath the oscillating portion.

4. The oscillating power generator of claim 1, wherein the two oscillating magnetic portions are respectively embedded on the left and right sides within the top of the oscillating portion, while the two fixed magnetic portions are positioned on the outer left and right sides above the oscillating portion.

5. The oscillating power generator of claim 1, wherein the fixed magnetic portion is a permanent magnet.

6. The oscillating power generator of claim 1, wherein the fixed magnetic portion is a renewable-energy electromagnet; and the fixed magnetic portion is a solar-charged electromagnet.

7. The oscillating power generator of claim 1, wherein each of two lateral sides of the oscillating portion has an extending portion extended therefrom, and the two oscillating magnetic portions are respectively installed in the two extending portions.

8. The oscillating power generator of claim 1, wherein the power generation apparatus generates power by using the Lenz's law to change the magnetic force between the magnet and the coil through repeated oscillations.

9. The oscillating power generator of claim 1, wherein the power generation apparatus is arranged on a surface in contact with the oscillating portion when the oscillating portion oscillating, and the power generation apparatus generates power by using Piezoelectric Effect to repeatedly exert pressure to the power generation apparatus through the oscillating portion.

10. The oscillating power generator of claim 1, wherein the power generation apparatus generates power by using the oscillating portion to carry out the mechanism motion.
